(19) United States
(12) Patent Application Publication
(10) Pub. No.: US 2021/0401642 A1
(43) Pub. Date: Dec. 30, 2021

(54) CHILD MOBILITY DEVICE

(71) Applicant: Taylor Moreland, Centralia, MO (US)

(72) Inventor: Taylor Moreland, Centralia, MO (US)

(21) Appl. No.: 16/912,335

(22) Filed: Jun. 25, 2020

(51) Int. Cl. A61G 5/10; A61G 5/12

(52) U.S. Cl. CPC A61G 5/1067; A61G 5/1094; A61G 2200/14; A61G 5/12; A61G 5/1002; A61G 5/1097

(57) ABSTRACT

Techniques are disclosed to enable a mobility device for a toddler with gross motor disabilities. The mobility device has a skid plate of substantially rigid material having a front end and a back end and two rigid side plates. The mobility device also has two wheels rotatably attached to the rigid side plates by way of first and second axles. Additionally, it has a seat for supporting an underside of the child in an upright, seated position and an adjustable leg holder that moves up and down to support the child's legs and to keep the child in the upright, seated position. An adjustable backrest is provided to position the child an appropriate distance from the leg holder so that the leg holder holds the appropriate part of the child's legs.

### BACKGROUND

Mobility is an important part of physical and cognitive development for children. Children born with gross motor disabilities are frequently limited in terms of their mobility. Some children with gross motor disabilities may never be able to walk or crawl on their own or may only be able to traverse very short distances by dragging their body across the floor. Child-sized wheelchairs can offer some mobility to these children when they are old enough, strong enough, and experienced enough to use them. However, wheelchairs are limiting for children in a home environment as they tend to be heavy and large and do not allow the child to adequately maneuver independently.

### SUMMARY

Mobility devices are disclosed to enable a child with gross motor disabilities to maneuver around the child's environment. The mobility device comprises a skid plate of substantially rigid material having a front end and a back end and two rigid side plates. The mobility device also has two wheels rotatably attached to the rigid side plates by way of first and second axles. Additionally, it has a seat for supporting an underside of the child in an upright, seated position and an adjustable leg holder that moves up and down to support the child's legs and to keep the child in the upright, seated position. An adjustable backrest is provided to position the child an appropriate distance from the leg holder so that the leg holder holds the appropriate part of the child's legs.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWINGS

The figures described below depict various embodiments of the present invention. It is understood that these figures depict exemplary embodiments. The exemplary features illustrated in the figures are intended to represent these aspects of the various disclosed embodiments and not intended to limit the claimed scope to any particular feature. Further, whenever possible, the following description refers to the reference numerals included in the figures, in which features depicted in multiple figures are designated with consistent reference numerals.

FIG. 1A is a perspective view of a mobility device consistent with the present teachings shown in use by a toddler represented with dashed lines;

FIG. 1B is a perspective view of a mobility device consistent with the present teachings shown in use by a toddler represented with dashed lines with the removable tray table removed;

FIG. 2 is a plan view of a mobility device consistent with the present teachings;

FIG. 3 is a front view of a mobility device consistent with the present teachings; and

FIG. 4 is a side view of a mobility device consistent with the present teachings.

### DETAILED DESCRIPTION

The following text sets forth a detailed description of numerous different embodiments. However, it is understood that the detailed description is to be construed as exemplary only and does not describe every possible embodiment since describing every possible embodiment would be impractical. In light of the teachings and disclosures herein, numerous alternative embodiments may be implemented.

It is understood that, unless a term is expressly defined in this patent application using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

The following detailed description of the technology references the accompanying drawings that illustrate specific embodiments in which the technology may be practiced. The embodiments are intended to describe aspects of the technology in sufficient detail to enable those skilled in the art to practice the technology. Other embodiments may be utilized and changes may be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology may include a variety of combinations and/or integrations of the embodiments described herein.

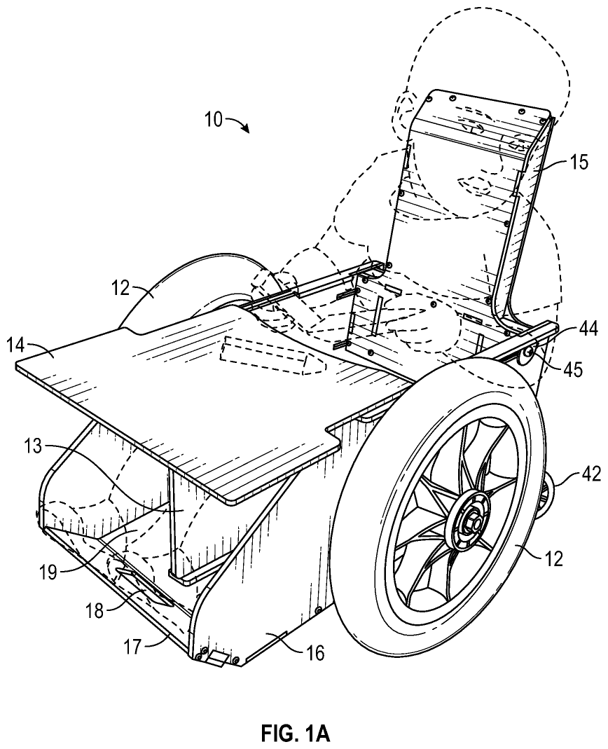

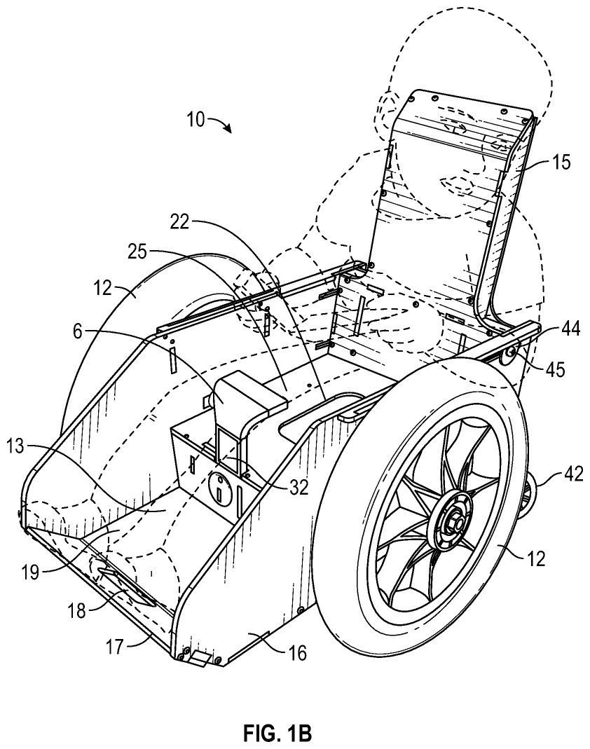

FIG. 1A is a perspective view of a mobility device 10 consistent with the present teachings shown in use by a toddler represented with dashed lines. In various embodiments, 6 mm foam-core polyvinyl (PVC) plastic foam board is used to construct the body of the mobility device, which has the advantage of making the mobility devices of the present teachings much lighter than conventional toddler wheelchairs, in some cases less than half as heavy as conventional ones. It is understood that other materials can be substituted without departing from the present teachings, such as any suitable light-weight strong and substantially rigid material.

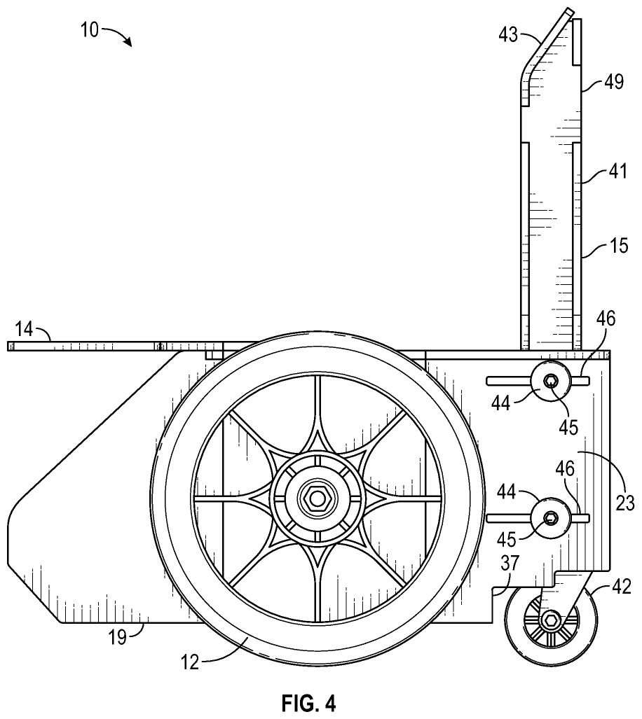

In various embodiments, removable tray table 14 can be removed. In various embodiments, it attaches with a hook-and-loop or touch fastener such as a Velcro™ type fastener (not shown). It is understood that other types of fasteners such as clips or snaps could be employed to removably fasten the removable tray table 14 to the mobility device 10. In various embodiments, removable tray support 13 is provided to support the removable tray table 14. In various embodiments, the sides and front of skid plate 19 are protected by a side shroud 16 and a front shroud 17, thus protecting the child's feet and legs from running into obstacles. In various embodiments, a carrying handle 18 is provided in connection with the front shroud 17. In an embodiment a second carrying handle is provided as further described in connection with FIG. 4 below.

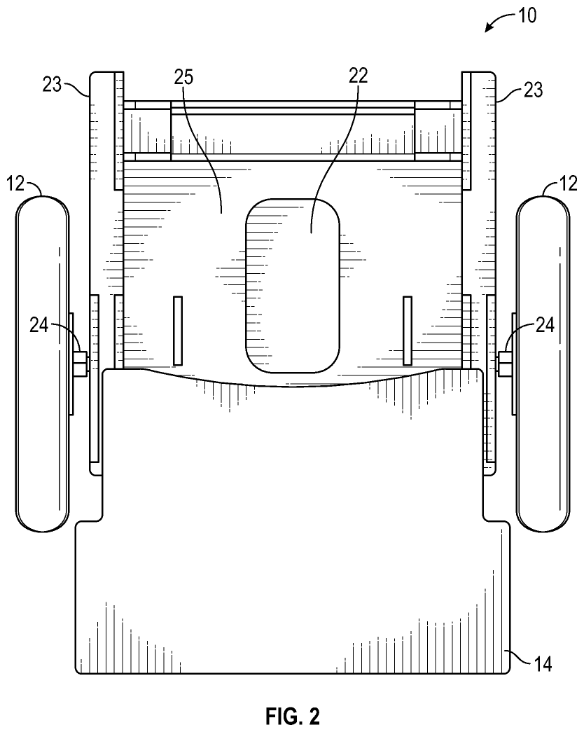

In various embodiments, backrest 15 is adjustably attached to sides of the mobility device 10 with bolts 45 and washers 44 as further described in connection with FIG. 4 below. The angle and position can be thereby altered by loosening the bolts 45 sliding into the desired position and retightening the bolts 45. This is to allow for different leg lengths of children. In various embodiments, straps are attached to the backrest 15 to hold the child's torso upright. Such straps are useful for children with low trunk support function. The backrest 15 can be removed and swapped for a lower or higher profile backrest 15 in addition to customizable trunk support backrests and pads. In various embodiments, it may also be folded flat and tucked under the removable tray table 14 for easier transport. In various embodiments, the backrest 15, a seat surface 25 (of FIG. 2), and the skid plate 19 are all flat areas making it easier for adjusting the fit of the mobility device 10 to a child user of a particular size and adding customized padding. Large wheels 12 are attached via axles, about which access the large wheels 12 rotate, to the side plate at a cambered angle to add stability and bring top of wheel closer to child's midline to allow for easier pushing.

FIG. 1B is a perspective view of the mobility device 10 consistent with the present teachings shown in use by a toddler represented with dashed lines with the removable tray table 14 removed. A potty chair hole 22 is visible in this figure with the removable tray table 14 of FIG. 1A removed. The potty chair feature is further described in connection with FIG. 2. In various embodiments, a leg holder 32 and a thigh support 6 are provided such that the leg holder 32 can be adjusted up and down with a bolt and washer similar to the way the backrest 15 can be adjusted. The thigh support 6 then supports the user's thighs as the leg holder 32 is brought down to hold the user's thighs in place depending on the thickness of the user's thighs thereby to support the user in an upright seated position. The adjustable backrest 15 is provided to position the child an appropriate distance from the leg holder 32 so that the thigh support 6 holds the appropriate part of the child's legs. In is understood that the leg holder 32 could move both forward and backward to work in connection with a backrest 15 that is not adjustable. In various embodiments both the backrest 15 and the leg holder 32 are fully adjustable.

In various embodiments, the sides and front of skid plate 19 are protected by a side shroud 16 and a front shroud 17, thus protecting the child's feet and legs from running into obstacles. In various embodiments, a carrying handle 18 is provided in connection with the front shroud 17. As noted, in various embodiments, the backrest 15 is adjustably attached to sides of the mobility device 10 with bolts 45 and washers 44. The angle and position can be thereby altered by loosening the bolts 45 sliding into the desired position and retightening the bolts 45. This is to allow for different leg lengths of children. In various embodiments, straps are attached to the backrest 15 to hold the child's torso upright. Such straps are useful for children with low trunk support function. In various embodiments, the large wheels 12 are attached to the side plate at a cambered angle to add stability and bring top of wheel closer to child's midline to allow for easier pushing.

FIG. 2 is a plan view of the mobility device 10 consistent with the present teachings. In various embodiments, padding (not shown) is provided on seat surface 25. In various embodiments, the padding is provided in different thickness or stacked to change ride height. In various embodiments, the padding can be swapped with pad with hole for potty chair feature that functions in connection with potty chair hole 22. In various embodiments, a tray or bin such as a plastic bin or bucket, is slid into the lower back slot as further described in connection with FIG. 4, by the caster wheels 42, for the potty chair feature. In connection with the plastic bin, a small trash bag can be used for the potty chair feature for easy clean up. In an embodiment, the plastic bag is inserted through the top of the seat into the tray underneath. Then unfurled for the child to sit on.

As noted above (and illustrated in connection with FIG. 4), the large wheels 12 are attached to the side plate at a cambered angle to add stability and bring top of wheel closer to child's midline to allow for easier pushing and maneuvering. The large wheels can be slid forward or backward in slots, using fasteners 24 analogously to the functionality of backrest 15 as further described in connection with FIG. 4 below. This makes it possible to change the center of gravity and adjust for different arm lengths/child sizes.

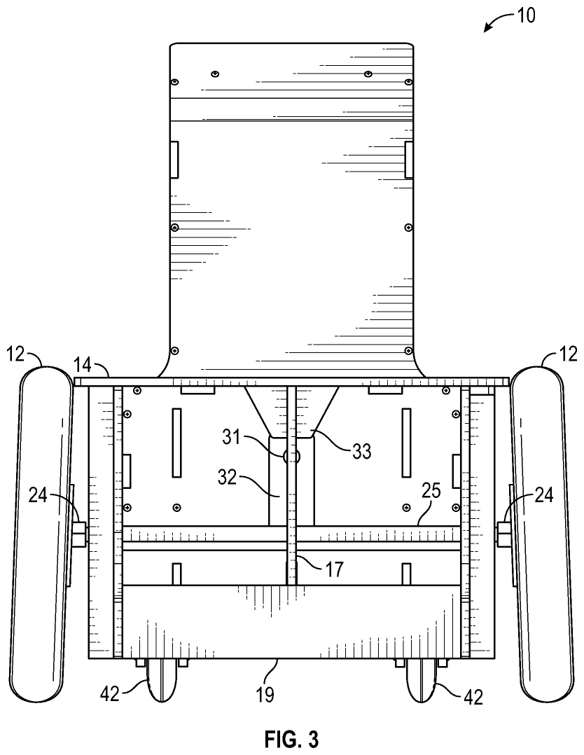

FIG. 3 is a front view of the mobility device 10 consistent with the present teachings. The small vertical piece at the front of the seat is a leg holder 32, that provides support for a child that requires support for sitting up. In various embodiments, the seat of the mobility device 10 has a thigh support 6 for supporting the user's legs and holding the user in place. In various embodiments, the thigh support 6 is an upside-down, triangular piece of padding over the top that facilitates holding the legs in place (as shown and further described in connection with FIG. 1B). In various embodiments, the leg holder 32 is adjustably mounted with a bolt through a slot. It is understood that other mechanisms can be employed to adjust the leg holder 32 up and down. Thereby as described in connection with FIG. 1A, the leg holder can be slid up and down to adjust for leg diameter so as to provide support to the user so that he or she is supported in an upright, seated position. The leg holder 32 and thigh support 6 and can be removed as well.

In various embodiments, the removable tray table 14 is supported by the tray support 13. In various embodiments additional horizontal tray support 33 is provided for additional support of the removable tray table 14.

FIG. 4 is a rear view of the mobility device 10 consistent with the present teachings. In various embodiments, the caster wheels 42 are at least approximately 3-inch diameter to provide stability and maneuverability. In an embodiment, they employ sealed bearings to roll and swivel. In various embodiments, the mobility device has a smooth skid plate 19 with ground clearance is at least approximately 1 and ¾ inches from the floor or ground to make going over obstacles easier for a user of the mobility device. In various alternative embodiments, the mobility device has a substantially similar seat height but with a ground clearance of at least approximately 3 and ¾ inches for use in rougher terrain such as gravel or grass, etc. In some of these embodiments, the potty chair feature is omitted. In various embodiments, a high-clearance is provided in connection with the potty chair feature. In various embodiments, mobility devices have differing heights to and sizes to accommodate users of differing heights.

In various embodiments, the backrest 15 is adjustably attached to a side plate 47 of the mobility device 10 with bolts 45 and washers 44 such that when the bolts 45 are loosened, the angle and position of the backrest 15 can be changed by loosening the bolts 45 sliding the backrest 15 into a desired position within slots 46 and 48 and retightening bolts. This is to allow for different leg lengths of children. If the position of a top one of the bolts 45 in the slot 46 is closer to the front of the mobility device 10 than a bottom one of the bolts 45, the backrest 15 will be tilted forward. Alternatively, if the top one of the bolts 45 is further from the front than the bottom one, the backrest 15 will be tilted backward. As shown in FIG. 4, the top and bottom bolts are vertically aligned and the backrest is substantially perpendicular to the seat of the mobility device 10. In various embodiments, the backrest is made up of a front piece 43 and a back piece 41. In an embodiment, a carrying handle opening 49 is formed in the back piece (as shown in section in FIG. 4). In various embodiments, a bin associated with the potty chair feature described above can be accessed via bin insert area 37.

Mobility in the device is very simple and intuitive for the user to achieve. The large wheels in the center of the device allow the user to traverse across many different surface types, from smooth flooring to thick carpeted flooring, and over small obstacles such as rugs or flooring transitions. These large wheels also allow the user to maneuver the device with a small amount of effort, allowing for users to use the device to traverse relatively long distances without fatigue. The center positioning of the wheels 12 ensures that the user has a low risk of getting a finger or hand caught or pinched underneath a wheel. As noted above, the relatively high positioning of skid plate 19 gives the device a high clearance so that the user is able to maneuver over obstacles such as small toys or features of outdoor terrain. This feature combined with previously stated features allows for this device to be used comfortably over an extended period of time.

Having thus described various embodiments of the technology, what is claimed as new and desired to be protected by Letters Patent includes the following:

1. A mobility device for a child with gross motor disabilities, the mobility device comprising:
a skid plate of substantially rigid material having a front end and a back end;
two rigid side plates;
two wheels rotatably attached to the rigid side plates by way of first and second axles;
a seat for supporting an underside of the child in an upright, seated position;
an adjustable leg holder that moves up and down to support the child's legs and to keep the child in the upright, seated position; and
an adjustable backrest.

2. The mobility device of claim 1 further comprising a removeable tray table.

3. The mobility device of claim 2, wherein the wheels are cambered.

4. The mobility device of claim 2, wherein a position of the first and second axles can be adjusted forward and backwards.

5. The mobility device of claim 3, wherein the backrest can be adjusted forward and backward and can be tilted forward and backward.

6. The mobility device of claim 5 further comprising swivel caster wheels attached to a rear portion of the mobility device.

7. The mobility device of claim 5 further comprising shrouds attached to the front end of the skid plate to protect the child's legs and feet.

8. A mobility device for a child with gross motor disabilities, the mobility device comprising:
a skid plate of substantially rigid material having a front end and a back end;
two rigid side plates;
two wheels rotatably attached to the rigid side plates by way of first and second axles;
a seat for supporting an underside of the child in an upright, seated position;
an adjustable leg holder that moves up and down to support the child's legs and to keep the child in an upright, seated position; and
an adjustable backrest that can be adjusted forward and backward to hold the child in place.

9. The mobility device of claim 8 further comprising a removeable tray table.

10. The mobility device of claim 9, wherein the wheels are cambered.

11. The mobility device of claim 9, wherein a position of the first and second axles can be adjusted forward and backwards.

12. The mobility device of claim 8, wherein the backrest can be tilted forward and backward.

13. The mobility device of claim 10, further comprising swivel caster wheels attached to a rear portion of the mobility device.

14. The mobility device of claim 10, further comprising shrouds attached to the front end of the skid plate to protect the child's legs and feet.

15. A mobility device for a child with gross motor disabilities, the mobility device comprising:
a skid plate of substantially rigid material having a front end and a back end;
two rigid side plates;
two wheels rotatably attached to the rigid side plates by way of first and second axles, wherein a position of the first and second axles can be adjusted forward and backwards;
a seat for supporting an underside of the child in an upright, seated position, wherein the seat defines an opening that can be used as a potty chair feature;
an adjustable leg holder that moves up and down to support the child's legs and to keep the child in an upright, seated position; and
an adjustable backrest that can be adjusted forward and backward to hold the child in place.

16. The mobility device of claim 15 further comprising a removeable tray table.

17. The mobility device of claim 16, further comprising a bin positioned below the seat for use in connection with the potty chair feature.

18. The mobility device of claim 15, wherein the backrest can be tilted forward and backward.

19. The mobility device of claim 17, further comprising swivel caster wheels attached to a rear portion of the mobility device.

20. The mobility device of claim 15, further comprising shrouds attached to the front end of the skid plate to protect the child's legs and feet.
